(19) United States
(12) Patent Application Publication
(10) Pub. No.: US 2013/0173837 A1
(43) Pub. Date: Jul. 4, 2013

(54) METHODS AND APPARATUS FOR IMPLEMENTING PCI EXPRESS LIGHTWEIGHT NOTIFICATION PROTOCOLS IN A CPU/MEMORY COMPLEX

(71) Applicants: Stephen D. Glaser, San Francisco, CA (US); Mark D. Hummel, Franklin, MA (US)

(72) Inventors: Stephen D. Glaser, San Francisco, CA (US); Mark D. Hummel, Franklin, MA (US)

(73) Assignee: ADVANCED MICRO DEVICES, INC., Sunnyvale, CA (US)

(21) Appl. No.: 13/341,150

(22) Filed: Dec. 30, 2011

(51) Int. Cl. G06F 13/36; G06F 12/00; G06F 12/08

(52) U.S. Cl. 710/314; 711/125; 711/108; 711/E12.02; 711/E12.001

(57) ABSTRACT

Methods and apparatus are provided for implementing a lightweight notification (LN) protocol in the PCI Express base specification which allows an endpoint function associated with a PCI Express device to register interest in one or more cachelines in host memory, and to request an LN notification message from the CPU/memory complex when the content of a registered cacheline changes. The LN notification message can be unicast to a single endpoint using ID-based routing, or broadcast to all devices on a given root port. The LN protocol may be implemented in the CPU complex by configuring a queue or other data structure in system memory for LN use. An endpoint registers a notification request by setting the LN bit in a “read” request of an LN configured cacheline.

### TECHNICAL FIELD

Embodiments of the subject matter described herein relate generally to PCI express lightweight notification implementation mechanisms. More particularly, embodiments of the subject matter relate to host implementation of LN notification protocols.

### BACKGROUND

PCI Express (peripheral component interconnect express), or PCIe, is the state of the art computer expansion card standard designed to replace the older PCI and PCI-X bus standards. Base specifications and engineering change notices (ECNs) are developed and maintained by the PCI special interest group (PCI-SIG) comprising more than 900 companies including Advanced Micro Devices, the Hewlett-Packard Company, and Intel Corporation. The PCIe bus serves as the primary motherboard-level interconnect for many consumer, server, and industrial applications, linking the host system processor with both integrated (surface mount) and add-on (expansion) peripherals.

The lightweight notification (LN) protocol was approved for PCIe base specification version 3.0 in October, 2011. The lightweight notification ECN provides an optional normative protocol which allows an endpoint function (e.g., a PCIe device) to register an interest in specified cachelines in host memory, and to request that an LN notification message be sent from the CPU/memory complex to the device when the contents of a registered cacheline changes. The LN protocol permits multiple LN-enabled endpoints to register the same cacheline(s) concurrently. Consequently, an LN notification message, generated when a registered cacheline is updated, may be unicast to a single endpoint using ID-based routing, or broadcast to multiple devices using multicast routing.

Although the potential increase in input/output (I/O) bandwidth and the potential decrease in I/O latency associated with the use of LN protocols are substantial, neither the PCIe standard nor the lightweight notification ECN define precisely how LN is to be implemented in the CPU/memory complex.

### BRIEF SUMMARY OF EMBODIMENTS

Exemplary methods and corresponding structure for implementing LN protocols in a central processing unit (CPU) memory complex are provided herein. The method implements a lightweight notification (LN) protocol in a central processing unit (CPU) host having associated system memory, and includes defining a range of system memory for use as an LN data structure, the range comprising a plurality of cachelines each having a length of N bytes, allocating a portion of each cacheline for LN storage and a portion for payload data, and configuring a first location in each cacheline as a routing field such that when the first location contains a first value its associated cacheline corresponds to a unicast LN message, and when the first location contains a second value its associated cacheline corresponds to a multicast LN message.

Various methods and corresponding structure for implementing LN protocols in a CPU host are also provided. An exemplary method of implementing lightweight notification (LN) protocols involves a host having a range of system memory designated for use as an LN data structure, the range including a plurality of cachelines each having a length of N bytes with an M<N byte subset of each cacheline reserved for LN storage. The method includes: configuring, for each said cacheline in the range, a first location in LN storage for use as a routing field, such that when the first location contains a first value its associated cacheline corresponds to a unicast LN message, and when the first location contains a second value its associated cacheline corresponds to a multicast LN message; configuring, for each said cacheline in the range, a portion of the N bytes for use as payload data; and sending an LN notification message from the host to a PCIe endpoint when the payload data of a registered cacheline is updated.

An exemplary embodiment of a CPU/memory complex is also provided for use with LN protocols. The system includes: A CPU complex configured to communicate with a PCIe endpoint device of the type including a lightweight notification request (LNR) module configured to send LN read and LN write request messages to the CPU complex, and to receive LN notification messages from the CPU complex, a range of system memory designated for use as an LN data structure, the memory range including a plurality of cachelines each having a length of N bytes with an M<N byte subset of each cacheline reserved for LN storage, and a processor including a lightweight notification completer (LNC) configured to send LN notification messages to the LNR

The foregoing summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic block diagram representation of an exemplary embodiment of a processor system and associated I/O devices;

FIG. 2 is a schematic block diagram representation of an exemplary embodiment of a CPU/memory complex, which is suitable for use in the processor system shown in FIG. 1;

FIG. 3 is a schematic diagram representation of an exemplary embodiment of basic LN read protocol operation;

FIG. 4 is a schematic diagram representation of an exemplary embodiment of basic LN write protocol operation;

FIG. 5 is a schematic block diagram representation of an exemplary embodiment of a cacheline layout showing LN storage and payload data bytes;

FIG. 6 is a schematic block diagram representation of an exemplary embodiment of LN storage layout for a unicast-configured cacheline;

FIG. 7 is a schematic block diagram representation of an exemplary embodiment of LN storage layout for a multicast-configured cacheline;

FIG. 8 is a flow chart that illustrates an exemplary embodiment of a method of implementing LN protocols in a PCIe compliant system; and

FIG. 9 is a flow chart that illustrates an exemplary embodiment of a method of sending an LN notification message in a PCIe system.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, logic elements, look-up tables, or the like, which may carry out a variety of functions under the control of one or more microprocessors or other control devices.

The subject matter presented here relates to methods and apparatus for implementing lightweight notification (LN) protocols in a host processor system. The processor system and/or one or more associated cache memory, system memory, or other data structure, modules or elements are configured for LN storage. More particularly, a predefined region of memory includes a plurality of cachelines, each having a length of N bytes. The cachelines may be configured in the form of any desired data structure such as, for example, a queue or ring buffer. A first subset of M bytes (M<N) is reserved as the LN storage mechanism, and a second subset of D bytes is allocated for payload data. Typically, (D+M)=N; that is, the entire cacheline is available for payload data, except for the N-byte portion of the cacheline reserved for LN storage. Alternatively, (D+M)<N, where the portion of the cacheline not used for LN storage or payload data may be used for other bookkeeping, software overhead, or other administrative purposes.

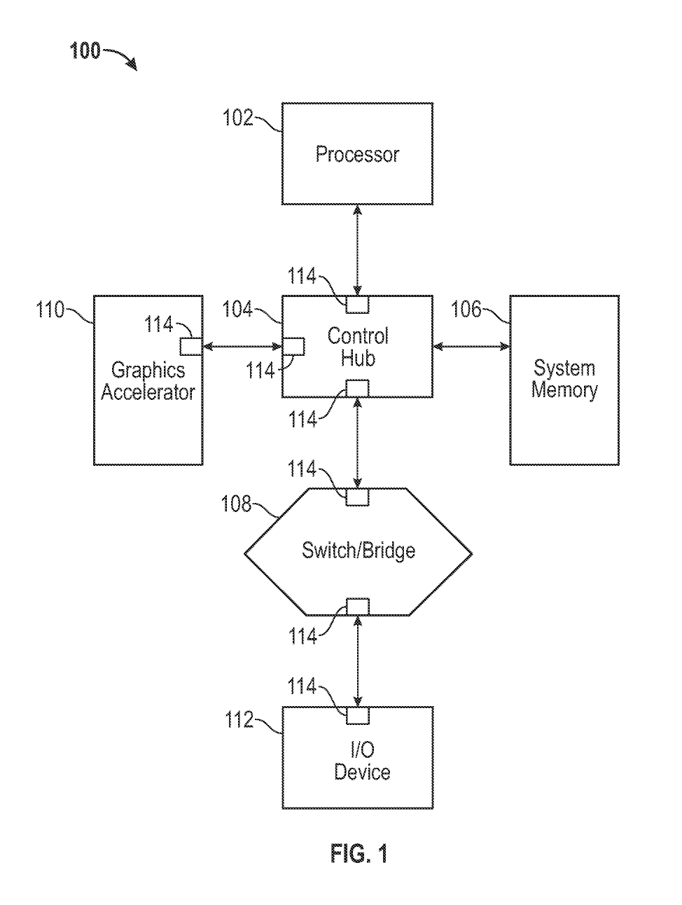

Referring now to the drawings, FIG. 1 is a schematic block diagram representation of an exemplary embodiment of a CPU/memory complex (processor system) 100. FIG. 1 depicts a simplified rendition of the CPU/memory complex 100, which may include a processor 102, a PCIe compliant controller hub 104 (also referred to as a root port or root complex) for connecting one or more PCIe end point devices 110 (e.g., a graphics controller), and a system memory 106 coupled to the processor 102, either directly or via controller hub 104. The system may also include an optional PCIe compliant switch/bridge 108 for connecting additional end point functions and/or devices such as, for example, one or more input/output (I/O) devices 112.

In the illustrated embodiment, one or more of controller hub 104, switch 108, and end point devices 110, 112 include respective I/O modules 114 configured to implement a layered protocol stack in accordance with, for example, the open systems interconnect (OSI) model. In an embodiment, I/O modules 114 facilitate PCIe compliant communication between and among processor 102, hub 104, switch 108, and devices 110 and 112.

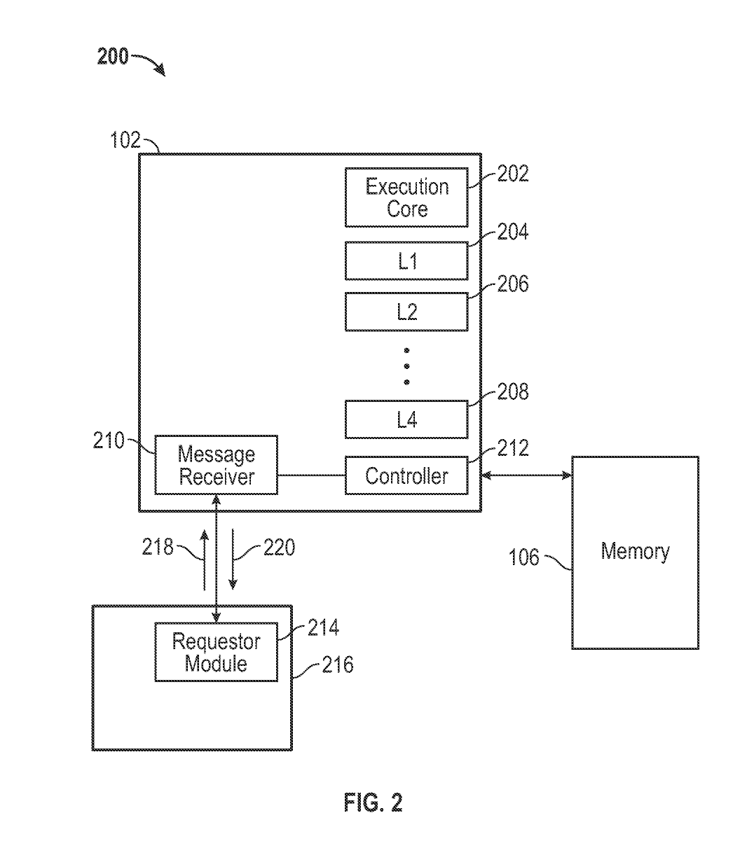

In the detailed embodiment shown in FIG. 2, the processor 102 may include, without limitation: an execution core 202; a level one (L1) cache memory 204; a level two (L2) cache memory 206; one or more further levels of cache memory (L4) 208; and a memory controller 212. The cache memories 204, 206, 208 are coupled to the execution core 202, and are coupled together to form a cache hierarchy, with the L1 cache memory 204 being at the top of the hierarchy and the L4 cache memory 208 being at the bottom. The execution core 202 may represent a processor core that issues demand requests for data. Responsive to demand requests issued by the execution core 202, one or more of the cache memories 204, 206, 208 may be searched to determine if the requested data is stored therein.

In one embodiment, the processor 102 may include multiple instances of the execution core 202, and one or more of the cache memories 204, 206, 208 may be shared between two or more instances of the execution core 202. For example, in one embodiment, two execution cores 202 may share the L4 cache memory 208, while respective instances of execution core 202 may have separate, dedicated instances of the L1 cache memory 204 and the L2 cache memory 206. Other arrangements are also possible and contemplated. Those skilled in the art will appreciate that PCIe compliant links are configured to maintain coherency with respect to processor caches and system memory as provided for in PCIe base specification version 3.0, which is available at http://www.pcisig.com/specifications/pciexpress.

The processor 102 also includes the memory controller 212 in the embodiment shown. The memory controller 212 may provide an interface between the processor 102 and the system memory 106, which may include one or more memory banks. The memory controller 212 may also be coupled to each of the cache memories 204, 206, 208. More particularly, the memory controller 212 may load cache lines (i.e., blocks of data stored in system memory) directly into any one or all of the cache memories 204, 206, 208. In one embodiment, the memory controller 212 may load a cache line into one or more of the cache memories 204, 206, 208 responsive to a demand request by the execution core 106.

As briefly discussed above, the LN protocol enables endpoints to register interest in specific cachelines in host memory, and to be notified via a hardware mechanism when the contents of a registered cacheline are updated. With continued reference to FIG. 2, processor 102 is configured to communicate with a PCIe compliant endpoint device 216. To facilitate LN protocol implementation, endpoint device 216 includes an LN requester (LNR) module 214, and processor 102 includes an LN completer (LNC) module 210. LNR 214 is a client subsystem that sends LN read and LN write requests (referred to as LN read/write requests) 218 to processor 102, and receives LN notification messages 220 from processor 102. LNC 210 and LNR 214 may be implemented as part of an I/O module 114 (not shown in FIG. 2 for clarity) for use in implementing an OSI protocol stack.

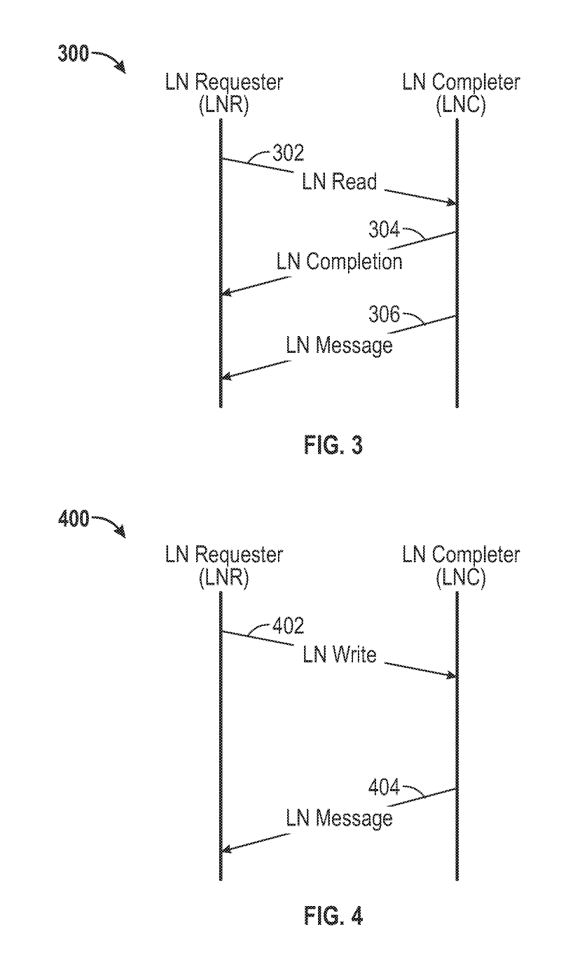

The processor system 100 may be configured to operate in the manner described in detail below. For example, FIGS. 3 and 4 are flow diagrams that illustrate exemplary embodiments of basic LN protocol read and write operations, which may be performed by the processor system 100. The various tasks performed in connection with processes described here may be performed by software, hardware, firmware, or any combination thereof. For illustrative purposes, the description of a process may refer to elements mentioned in connection with the various drawing figures. In practice, portions of a described process may be performed by different elements of the described system, e.g., the execution core 202, memory controller 212, controller hub 104, LNC 210, LNR 214, or other logic in the system.

It should be further appreciated that a described process may include any number of additional or alternative tasks, the tasks shown in the figures need not be performed in the illustrated order, and that a described process may be incorporated into a more comprehensive procedure or process having additional functionality not described in detail herein. Moreover, one or more of the tasks shown in the figures could be omitted from an embodiment of a described process as long as the intended overall functionality remains intact.

With continued reference to FIGS. 2 and 3, LNR 214 associated with endpoint device 216 requests a copy of a line from host memory by sending an LN read message 302 to LNC 210. In response, processor 102 retrieves the requested line and LNC 210 returns the requested line to LNR 214 via an LN completion message 304. In accordance with the LN implementation mechanisms described below, LNC 214 records that LNR 210 has requested a “watch” of the requested line; that is, LNC 214 makes a record that LNR 210 has registered an interest in a particular cacheline in host memory. LNC 210 subsequently notifies LNR 214 through an LN notification message 306 when the contents of the registered cacheline are updated.

FIG. 4 is a flow diagram that illustrates one particular exemplary embodiment of a basic LN protocol write operation 400. More particularly, LNR 210 writes to a line in host memory by sending an LN write message 402 to LNC 210. LNC 214 records that LNR 210 has registered the line, and later notifies LNR 210 through an LN notification message 404 when the registered line is updated.

The LN protocol permits multiple LNRs to register the same line concurrently. In this case, LNC 210 notifies the multiple LNRs either by sending a directed LN notification message to each requesting LNR, or by sending a broadcast LN notification to each root port associated with an LNR which has registered a watch request.

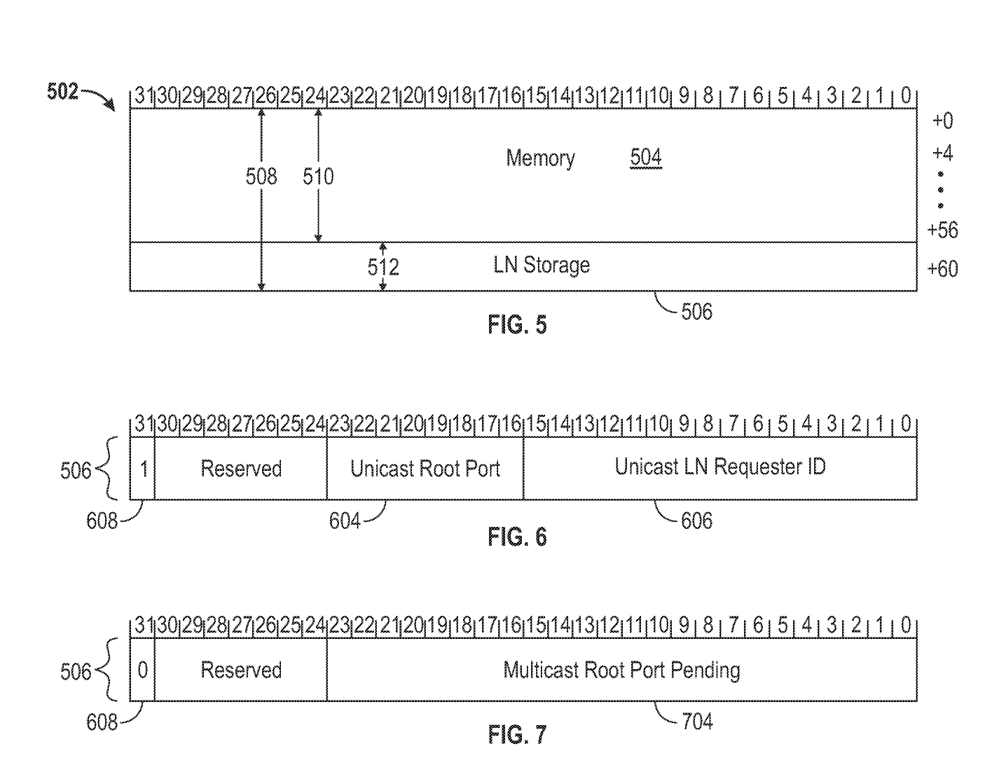

Referring now to FIG. 5, a schematic diagram representation of an exemplary embodiment of a cacheline or cache block 502 is shown. Cacheline 502 is illustrated as a 32-bit wide memory line; however, cacheline 502 may be 64-bits, 128-bits, or any suitable width. As shown, cacheline 502 has a length “N” (indicated by the arrow 508) of 64-bytes, but may also be any desired length, e.g., 128-bytes, 256-bytes, or the like.

In accordance with an embodiment, cacheline 502 exhibits a co-located layout in which the LN storage data and payload data are co-located in the same cacheline. In particular, cacheline 502 includes payload region 504 and LN storage region 506. In one embodiment, payload (memory) region 504 has a length “D” (indicated by the arrow 510) of 60-bytes, and LN storage region 506 has a length “M” (indicated by the arrow 512) of 4-bytes. Alternatively, LN storage region 506 may be any desired number of bytes (or data words) in length such that M=1, 2, 8, etc. Similarly, memory region 504 may be any desired number of bytes or words in length such that the total byte length D of cacheline 502 is equal to the sum of the payload data byte length D plus the LN storage byte length M; that is, N=D+M.

In an alternate embodiment, the total byte length N of cacheline 502 is less than the sum of the payload data byte length D and the LN storage byte length M; that is, N<(D+M) where the difference is attributable to bookkeeping, software overhead, administration, or the like. It should be noted that LN storage portion 506 is reserved for the LN storage mechanism and, typically, not otherwise usable by the device; thus, the range of system memory (i.e., the plural cachelines 502) utilizes an altered programming model from regular system memory in that the programming model is adapted to implement the LN storage mechanisms described herein.

A variety of implementations are possible and contemplated by the schematic layout shown in FIG. 5. In an exemplary embodiment, FIG. 6 shows a schematic block diagram representation of an LN storage layout for a unicast-configured cacheline. Specifically, a first location 608 (for example, bit 31 in FIG. 6) of LN storage 506 may be designated for use as a routing field, such that when the first location 608 contains a first value (for example, “1”) the LN storage mechanism associated with the cacheline is configured to generate a unicast LN notification message; that is, an LN notification message 220 (see FIG. 2) will be directed to a single endpoint function when the contents of cacheline 502 are updated.

The endpoint device and/or endpoint function to which the unicast notification message is to be directed may be defined by one or more second locations 604, 606 within LN storage 506 designated for use as a destination field. In FIG. 6, the destination field includes the unicast root port ID field 604 and the requester ID field 606.

Referring now to FIGS. 5 and 7, if the routing field (i.e., first location 608) contains a second value (for example, “0” in FIG. 7), the LN storage mechanism associated with cacheline is configured to generate a multicast LN notification message; that is, an LN notification message 220 (see FIG. 2) will be directed to multiple endpoint functions/devices when the contents of cacheline 502 are updated.

The endpoint devices and/or endpoint functions to which the multicast notification message is to be broadcast may be defined by one or more second locations 704 within LN storage 506 designated for use as a destination field. In FIG. 7, the destination field includes a multicast root port ID field 704 which identifies the root ports of all requesting devices and/or endpoints.

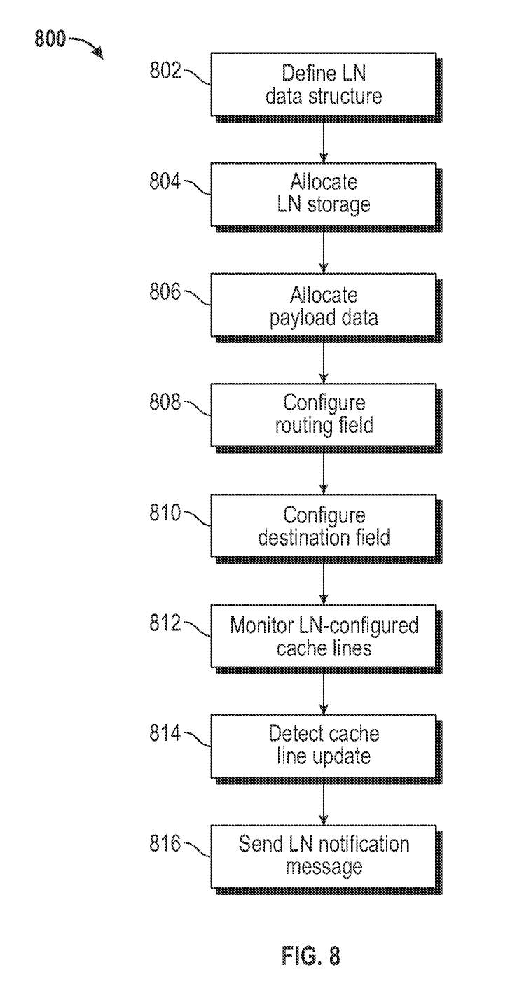

FIG. 8 is a flow chart that illustrates an exemplary embodiment of a method of implementing LN protocols in a PCIe-enabled system in accordance with various embodiments. The method 800 includes defining (task 802) a range of system memory for use as an LN data structure. In an embodiment, the LN-configured memory range includes a plurality of cachelines each having a length of N-bytes (as shown, for example, in FIG. 5). The method 800 allocates (task 804) an M<N-byte subset of each cacheline in said range for use as an LN storage mechanism. The method 800 further allocates (task 806) a D<N-byte subset of each cacheline for payload data, where (D+M) is less than or equal to N.

With continued reference to FIG. 8, the method 800 also configures (task 808), for each LN-configured cacheline, a first location in LN storage for use as a routing field, such that when the first location contains a first value its associated cacheline corresponds to a unicast LN notification message, and when the first location contains a second value its associated cacheline corresponds to a multicast LN notification message as described above in connection with FIGS. 6 and 7. The method further configures (task 810) a second location within LN storage for use as a destination field. In an exemplary embodiment, the second location includes a unique requester ID when the first location contains a first value (for example, “1” in FIG. 6), and the second location includes a plurality of root port IDs when the first location contains a second value (“0” in FIG. 6).

The method 800 further includes monitoring (task 812) each LN-configured cacheline and detecting (task 814) a change in the contents of the payload data bytes associated with a registered cacheline. When the system determines that a cacheline has been updated, the method 800 sends (task 816) a notification message to the requesting endpoint device(s) as discussed in connection with FIGS. 3 and 4.

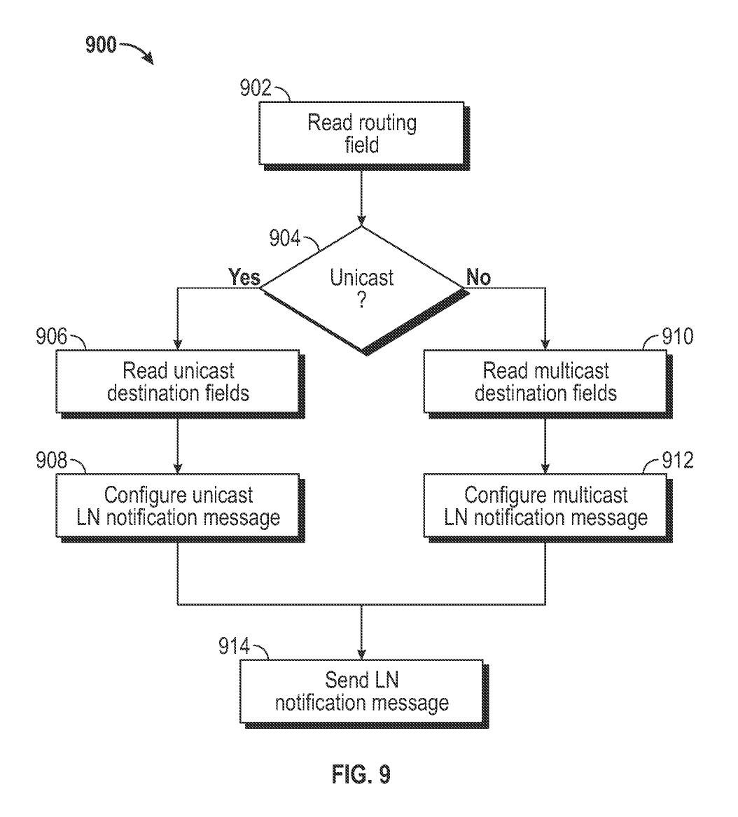

Referring now to FIG. 9, a flow chart illustrates an exemplary method 900 of configuring and sending an LN notification message in a PCIe system. More particularly and with momentary reference to FIGS. 5-8, the system reads (task 902) first location 608 (the routing field) of LN storage 506 and determines the value stored therein. If the value in first location 608 indicates that a single endpoint has registered the subject cacheline (“yes” branch from task 904), the system reads (task 906) the unicast destination fields 604, 606 from LN storage 506 and configures (task 908) a unicast LN notification message. If, on the other hand, the value in first location 608 indicates that a more than one endpoint has registered the subject cacheline (“no” branch from task 904), the system reads (task 910) the multicast destination field 704 from LN storage 506 and configures (task 912) a multicast LN notification message. Having assembled an LN notification message in response to the detection of a change in payload data for a registered cacheline, the method 900 sends (task 914) the LN notification message to the appropriate endpoint(s).

In an embodiment, the method 900 may be configured too dynamically switch between the unicast and broadcast modes of operation. For example, if only one requester has registered an interest in a particular line, the unicast mode is employed. If a second or subsequent request is registered for the same line, the method converts to the broadcast mode. If the line is eventually evicted (and thereby causing eviction notices to be sent), the method again starts in unicast the next time a request is registered for that line.

In an alternate embodiment, the LN storage mechanism is stored in a pre-configured range in system memory as above, but the LN storage fields are located separate from the registered cacheline. That is, each LN capable cacheline has an associated LN storage are that is located in another cacheline. In this way, the entire cacheline may still be used as memory, and the memory address of the registered cacheline is used to determine the location (memory address) of the corresponding LN storage area. When the cacheline is modified (or when an LN operation is processed), two separate cachelines are affected; a first cacheline containing the payload data, and a second associated cacheline which stores the LN mechanism (e.g., the routing, destination, or other LN-related information).

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method of implementing a lightweight notification (LN) protocol in a central processing unit (CPU) memory complex having associated system memory, the method comprising:
defining a range of said system memory for use as an LN data structure, said range comprising a plurality of cachelines each having a length of N bytes;
allocating an M<N byte subset of each cacheline in said range for LN storage;
allocating a D<N byte subset of each cacheline in said range for payload data, where (D+M) is less than or equal to N; and
configuring, for each said cacheline in said range, a first location in said LN storage for use as a routing field, such that when said first location contains a first value its associated cacheline corresponds to a unicast LN message, and when said first location contains a second value its associated cacheline corresponds to a multicast LN message.

2. The method of claim 1, wherein said cachelines comprise 32 bit cachelines.

3. The method of claim 1, wherein N=64.

4. The method of claim 1, wherein N=128.

5. The method of claim 1, wherein M is an integer value in the range of 1 to 8.

6. The method of claim 1, wherein M=4.

7. The method of claim 1, further comprising:
configuring, for each said cacheline in said range, a second location within said LN storage for use as a destination field, such that said second location includes a unique requester ID when said first location contains said first value, and said second location includes a plurality of root port IDs when said first location contains said second value.

8. The method of claim 7, further comprising:
monitoring, for each cacheline in said range, said payload data bytes;
detecting a change in the contents of said payload data bytes; and
sending a notification message upon detection of a change in the contents of said payload data bytes.

9. The method of claim 8, wherein sending a notification message comprises:
sending a unicast message to said unique requester ID if said first location contains said first value; and
sending a broadcast message from said plurality of root port IDs if said first location contains said second value.

10. The method of claim 9, wherein said LN data structure is configured as a queue.

11. The method of claim 10, wherein said queue is implemented as a ring buffer.

12. The method of claim 8, wherein monitoring said payload data bytes comprises placing an address corresponding to a respective one of said cachelines in a content addressable memory (CAM) register.

13. A method of implementing a lightweight notification (LN) protocol in a host having a range of system memory designated for use as an LN data structure, said range comprising a plurality of cachelines each having a length of N bytes with an M<N byte subset of each cacheline reserved for LN storage, the method comprising:
configuring, for each said cacheline in said range, a first location in said LN storage for use as a routing field, such that when said first location contains a first value its associated cacheline corresponds to a unicast LN message, and when said first location contains a second value its associated cacheline corresponds to a multicast LN message;
configuring, for each said cacheline in said range, a portion of said N bytes for use as payload data; and
sending an LN notification message from said host to a PCIe endpoint when the contents of said payload data of a registered one of said cachelines is updated.

14. The method of claim 13, wherein sending an LN notification message comprises directing a unicast message to a single PCIe endpoint when said first location contains said first value.

15. The method of claim 13, wherein sending an LN notification message comprises sending a broadcast message to plural PCIe endpoints when said first location contains said second value.

16. The method of claim 13, further comprising configuring, for each cacheline in said range, a second location in said LN storage as a destination field for identifying said PCIe endpoint.

17. A CPU complex configured to communicate with a PCIe endpoint device of the type including a lightweight notification request (LNR) module configured to send LN read and LN write request messages to the CPU complex, and to receive LN notification messages from the CPU complex, the CPU complex comprising:
a range of system memory designated for use as an LN data structure, said range comprising a plurality of cachelines each having a length of N bytes with an M<N byte subset of each cacheline reserved for LN storage; and
a processor including a lightweight notification completer (LNC) configured to send said LN notification messages to said LNR.

18. The CPU complex of claim 17, wherein said LNC is configured to implement an open systems interconnect (OSI) protocol stack.

19. The CPU complex of claim 17, wherein said M-byte subset comprises a first location for use as a routing field and a second location for use as a destination field.

20. The CPU complex of claim 19, wherein said LNC is configured to send a unicast LN notification message to a single destination identified in said destination field when said first location contains a first value, and to send a multicast LN notification message to multiple destinations identified in said destination field when said first location contains a second value.
